(19) United States
(12) Patent Application Publication
(10) Pub. No.: US 2015/0035867 A1
(43) Pub. Date: Feb. 5, 2015

(54) LIQUID CRYSTAL DISPLAY DEVICE AND METHOD OF DRIVING THE SAME

(71) Applicant: Samsung Display Co., Ltd., Yongin-city (KR)

(72) Inventors: Dong-Min YEO, Asan-si (KR); Gicherl KIM, Asan-si (KR); Young-keun LEE, Suwon-si (KR)

(73) Assignee: Samsung Display Co., Ltd., Yongin-city (KR)

(21) Appl. No.: 14/178,845

(22) Filed: Feb. 12, 2014

(30) Foreign Application Priority Data
Jul. 30, 2013 (KR) 10-2013-0090286

(51) Int. Cl. G09G 3/36

(52) U.S. Cl. CPC G09G 3/3607
USPC 345/690; 345/88

(57) ABSTRACT

A liquid crystal display device that includes: a light source unit comprising light-emitting diodes that belong to color coordinate ranks, according to variations in the color coordinates of white light emitted thereby; and a display panel comprising pixels configured to display an image by selectively emitting light received from the light-emitting diodes; and a color correction module configured to compensate a color coordinate of a white color gradation of the image, by controlling the display panel to adjust an intensity of light emitted from one or more of the pixels, according to the color coordinate ranks of corresponding light-emitting diodes that provide light to the pixels.

### CROSS-REFERENCE TO RELATED APPLICATION

This U.S. non-provisional patent application claims priority under 35 U.S.C. §119 of Korean Patent Application No. 10-2013-0090286, filed on Jul. 30, 2013, which is hereby incorporated by reference for all purposes as if fully set forth herein.

### BACKGROUND

1. Field

The present disclosure relates to a liquid crystal display device and a method of driving the same, and more particularly, to a liquid crystal display device having improved display quality and reduced manufacturing costs and a method of driving the same.

2. Discussion of the Background

In general, a backlight assembly is classified into an edge-type backlight assembly and a direct-type backlight assembly, depending on the position of a light-emitting diode that generates light. The edge-type backlight assembly has a structure in which a light-emitting diode is disposed on a side of a light guide plate. The direct-type backlight assembly has a structure in which light-emitting diodes are disposed on the bottom of the light guide plate.

Moreover, light-emitting diodes may be configured to emit white light. During manufacturing processes, since there is a difference in the amount of phosphor included in each light-emitting diode, the color coordinates of light emitted from different light-emitting diodes may vary. Accordingly the color coordinates of an image produced using the light-emitting diodes may vary.

### SUMMARY

The present disclosure provides a liquid crystal display device capable of compensating for the white color gradation of a displayed image and a method of driving the same.

Additional features of the present disclosure will be set forth in the description which follows, and in part will be apparent from the description, or may be learned by practice of the present teaching.

Embodiments of the inventive concept provide liquid crystal display devices including: a light source unit comprising light-emitting diodes that belong to a same color coordinate rank, according to variations in the color coordinates of white light emitted thereby; and a display panel comprising pixels configured to display an image by selectively emitting light received from the light-emitting diodes; and a color correction module configured to compensate for a color coordinates of a white color gradation of the image by controlling the display panel to adjust an intensity of light emitted from one or more of the pixels, according to the color coordinate rank of corresponding light-emitting diodes that provide light to the pixels.

In other exemplary embodiments of the inventive concept, provided are methods of driving a display device to display an image by using a light emitted from a light-emitting diodes that belong to a same color coordinate rank, according to variations in the color coordinates of white light emitted thereby, the method comprising: receiving external source data; converting the source data into image data on the basis of a compensation value corresponding to the color coordinate rank of the light emitting diodes; converting the image data into a data signal; providing the data signal to pixels; and correcting an intensity of a light emitted from at least one of pixels to compensate for a color coordinate of a white color gradation of the image.

It is to be understood that both the foregoing general description and the following detailed description are exemplary and explanatory and are intended to provide further explanation of the present teachings as claimed.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept.

FIG. 1 is an exploded perspective view of a liquid crystal display device according to an embodiment of the inventive concept.

FIG. 2 is a view illustrating CIE color coordinates representing a plurality of color coordinate ranks where light-emitting diodes are distributed according to an exemplary embodiment of the inventive concept.

FIG. 3 is a graph illustrating a light-emitting spectrum according to an exemplary embodiment of the inventive concept.

FIG. 4 is a plan view of a light source unit according to an exemplary embodiment of the inventive concept.

FIG. 5 is a view illustrating the brightness distribution of a light source unit at the position I-I′ shown in FIG. 4.

FIG. 6 is a block diagram of a liquid crystal display device according to an exemplary embodiment of the inventive concept.

FIG. 7 is a block diagram of a color correction module according to an exemplary embodiment of the inventive concept.

FIG. 8 is a block diagram illustrating a color correction module according to an exemplary embodiment of the inventive concept.

FIG. 9 is a block diagram illustrating a color correction module according to an exemplary embodiment of the inventive concept.

FIG. 10 is a color coordinate system representing the adjustment of the color coordinates of a white color gradation of an image to target color coordinates, according to an exemplary embodiment of the inventive concept.

FIG. 11 is a color coordinate system representing the adjustment of the color coordinates of a white color gradation of an image to target color coordinates, according to an exemplary embodiment of the inventive concept.

FIG. 12 is a color coordinate system representing the adjustment of the color coordinates of a white color gradation of an image to target color coordinates, according to an exemplary embodiment of the inventive concept.

### DETAILED DESCRIPTION OF THE ILLUSTRATED EMBODIMENTS

Exemplary embodiments of the inventive concept will be described below in more detail with reference to the accompanying drawings. Thus, it is intended that the inventive concept covers the modifications and variations of this invention provided they come within the scope of the appended claims and their equivalents.

Like reference numerals refer to like elements throughout. In the drawings, the dimensions of layers and regions are exaggerated for clarity of illustration. Also, though terms like a first and a second are used to describe various members, components, regions, layers, and/or portions in various embodiments of the inventive concept, the members, components, regions, layers, and/or portions are not limited to these terms. The terms of a singular form may include plural forms unless referred to the contrary.

The meaning of “include,” “comprise,” “including,” or “comprising,” specifies a property, a region, a fixed number, a step, a process, an element and/or a component but does not exclude other properties, regions, fixed numbers, steps, processes, elements and/or components. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

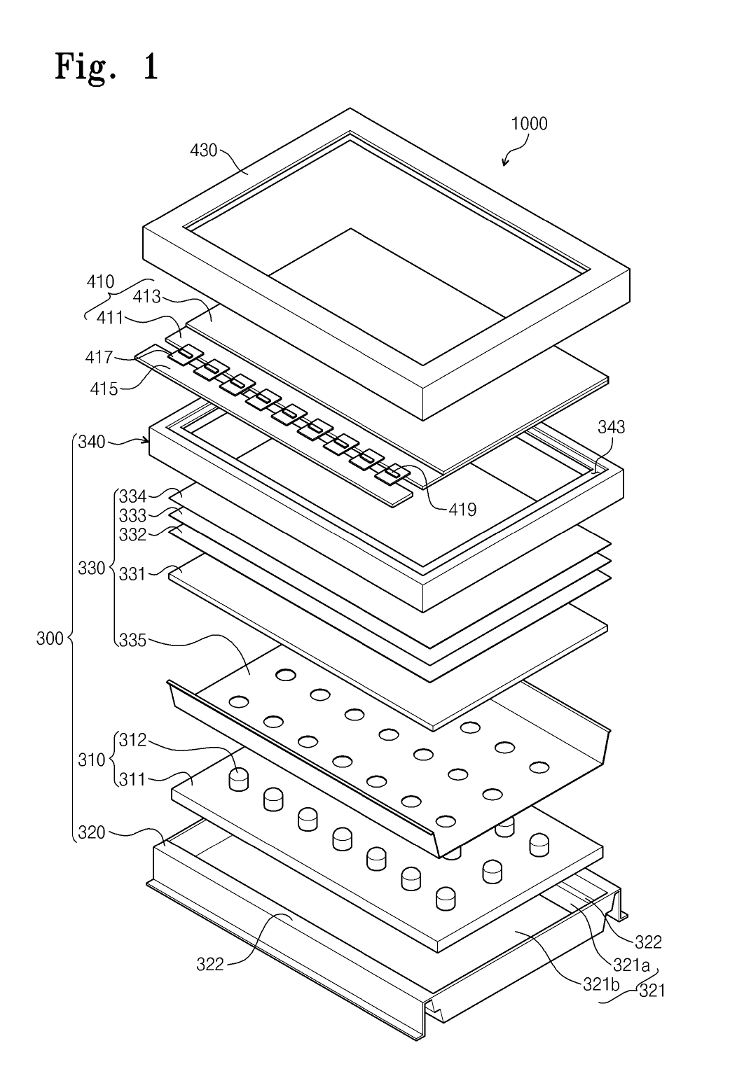

FIG. 1 is an exploded perspective view of a liquid crystal display device 1000 according to an embodiment of the inventive concept. Referring to FIG. 1, the liquid crystal display device 1000 includes a backlight assembly 300 to generate flat light and a display panel 410 to display an image by receiving the flat light.

The display panel 410 includes an array substrate 411, a facing substrate 413 facing the array substrate 411 and combined therewith, and a liquid crystal layer (not shown) disposed between the array substrate 411 and the facing substrate 413.

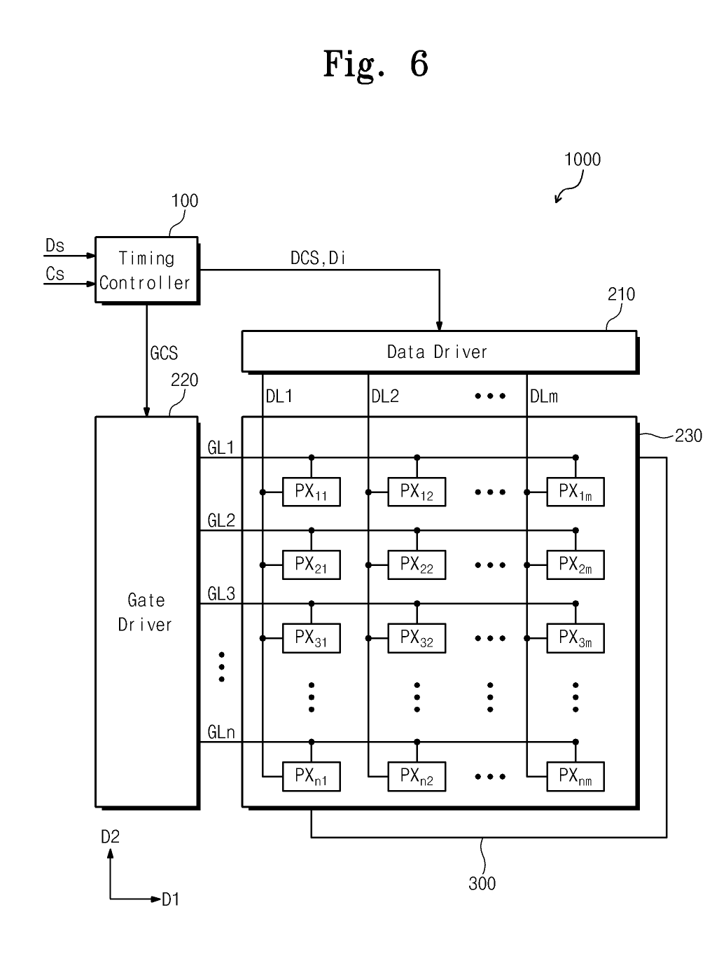

As shown in FIG. 6, the array substrate 411 may be a thin film transistor (TFT) substrate where TFTs, i.e., switching devices, are formed in a matrix. A plurality of data lines DL1 to DLm and a plurality of gate lines GL1 to GLn, as shown in FIG. 6, are connected to the source and gate terminals of the TFTs, respectively. Pixel electrodes formed of a transparent conductive material are connected to the drain terminals of the TFTs. The facing substrate 413 may include an RGB color filter, a black matrix, and a common electrode formed of a transparent conductive material.

The liquid crystal display device 1000 includes a printed circuit board 415 including a timing controller 100 for supplying a data driving signal DCS and a gate driving signal GCS to the display panel 410, and a driving circuit film 417 connecting the printed circuit board 415 to the display panel 410. The driving circuit film 417 may be formed of a tape carrier package (TCP) having a driving chip 419 mounted thereon, or a chip on film (COF).

The driving chip 419 may include a data driver 210 providing data signals to the data lines DL1 to DLm in response to a data driving signal. A gate driver 220 for providing gate signals to the plurality of gate lines GL1 to GLn of the display panel 410, in response to a gate driving signal GCS, may be built in the display panel 410 through a thin film process. The backlight assembly 300 includes a light source unit 310 for generating light, a receiving member 320, an optical member 330, and a frame member 340.

The receiving member 320 includes a receiving unit 321 for receiving the light source unit 310, and a support unit 322 for supporting the optical member 330. The receiving unit 321 has a bottom surface 321a and a sidewall 321b extending from the bottom surface 321a. The bottom surface 321a has a rectangular form. The sidewall 321b extends from the edge of the bottom surface 321a to form a receiving space for receiving the light source unit 310. For example, the receiving member 320 may be formed of an aluminum-based metal, which efficiently emits a heat generated by the light source unit 310 to the outside, and has excellent strength deformation resistance.

The optical member 330 receives light from the light source unit 310 and converts the received light into a flat light. The optical member 330 includes a diffusion plate 331, and optical sheets 332, 333, and 334. The diffusion plate 331 is disposed on the light source unit 310 to improve brightness uniformity by diffusing light emitted from the light source unit 310. The diffusion plate 331 may serve to support the optical sheets 332, 333, and 334, while preventing the same from being bent.

The optical sheets 332, 333, and 334 are disposed on the diffusion plate 331, and in order to improve the brightness characteristics of a light emitted from the diffusion plate 331, at least one sheet may be used. For example, the optical sheets 332, 333, and 334 may include one diffusion sheet 332 and two light condensing sheets 333 and 334.

The diffusion sheet 332 is disposed on the diffusion plate 331 and diffuses a light emitted from the diffusion plate 331. The diffusion sheet 332 may be formed of a transparent material, for example, a polyethylene terephthalate (PET) material.

The light condensing sheets 333 and 334 are disposed on the diffusion sheet 332, and condense the light diffused by the diffusion sheet 332, to improve front brightness. Each of the light condensing sheets 333 and 334 may include a fine prism pattern (not shown) having a prism form. Especially, a prism pattern extending in a first direction is formed on one of the light condensing sheets 333 and 334 and a prism pattern extending a second direction perpendicular to the first direction is formed on the other.

The backlight assembly 300 includes the frame member 340 between the optical member 330 and the display panel 410. The frame member 340 is combined with the receiving member 320 to fix the optical member 330 at the receiving member 320 and prevent a movement of the diffusion plate 331. Additionally, the frame member 340 supports the display panel 410. In more detail, the display panel 410 is seated on the frame member 340, and a panel guide unit 343 guiding the seated display panel 410 is further included.

The liquid crystal display device 1000 may further include a top chassis 430 that is combined with the frame member 340 and fixes the display panel 410 at the frame member 340. The top chassis 430 surrounds the border of the display panel 410 and fixes the display panel 410 at the panel guide unit 343 of the frame member 340. Accordingly, the top chassis 430 prevents the damage of the display panel 410 from external impacts and prevents the display panel 410 from being derailed from the panel guide unit 343 of the frame member 340.

The light source unit 310 includes a circuit substrate 311 and light-emitting diodes 312 mounted on the circuit substrate 311. The circuit substrate 311 is received in the receiving unit 321 to face the optical member 330. The light-emitting diodes 312 equipped on the circuit substrate 311 provide light toward the optical member 330 and a reflective sheet 335.

The light-emitting diode 312 emits white light. The light-emitting diode 312 may include a blue light-emitting body and a light-emitting phosphor. For example, the blue light-emitting body may be a blue light-emitting diode chip. The light-emitting phosphor is excited by the light of the blue light-emitting body to emit yellow light. A blue light emitted from the blue light-emitting body and a yellow light emitted from the light-emitting phosphor are mixed to provide white light.

Additionally, the top surface (i.e., the surface where the light-emitting diodes 312 are mounted) of the circuit substrate 311 may further include the reflective sheet 335. The reflective sheet 335 may have openings that correspond to the light-emitting diodes 312.

The reflective sheet 335 reflects incident light, which leaks toward the bottom of the light source unit 310, toward the optical member 330, so as to improve light use efficiency. For example, the reflective sheet 335 may be formed of a PET or polycarbonate (PC) material.

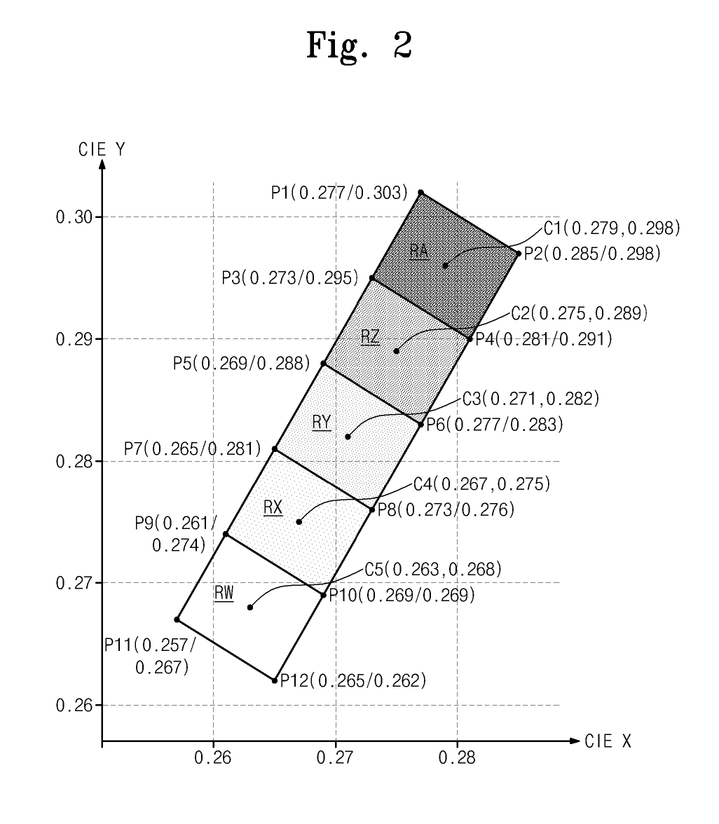

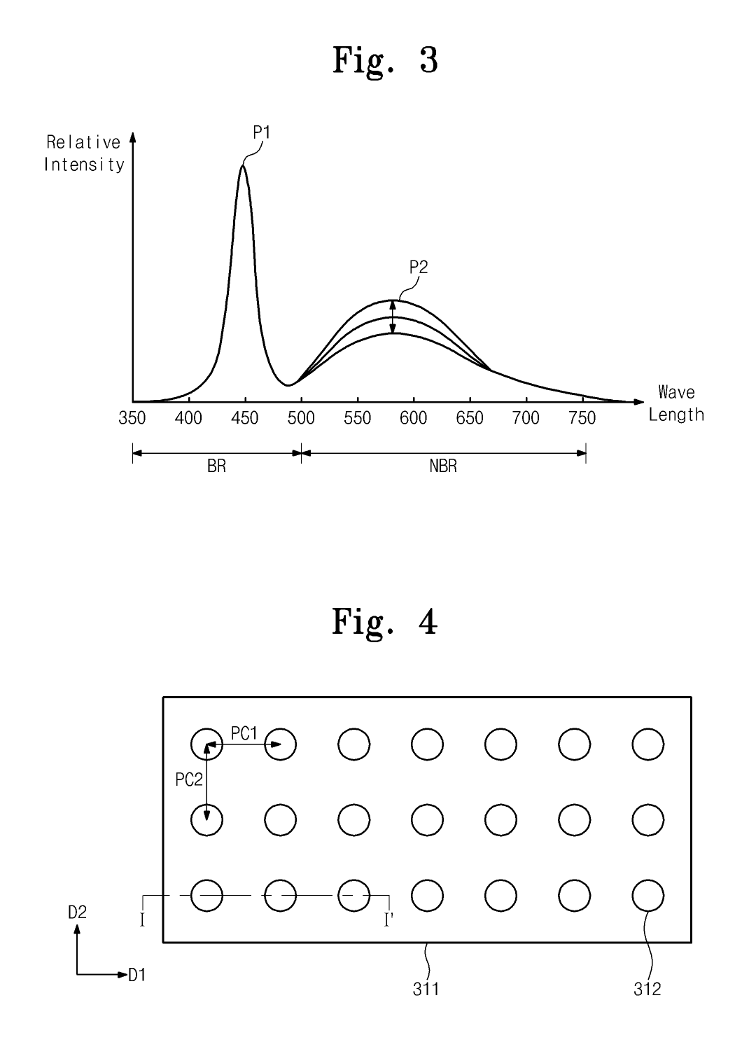

FIG. 2 is a view illustrating CIE color coordinates representing color coordinate ranks where light-emitting diodes are classified according to CIE color coordinates of the light output thereby. FIG. 3 is a graph illustrating a light-emitting spectrum, according to an exemplary embodiment of the inventive concept.

Referring to FIG. 2, white light emitted from each light-emitting diode 312 is classified into a color coordinate rank according to the color coordinates of the white light. The distribution of the wave length of the light produced by light-emitting diode 312 results from a dominant wavelength distribution P1 of FIG. 2 of a blue light-emitting diode chip and a distribution of a phosphor wavelength P2 of FIG. 3 due to a content a yellow phosphor. Each color coordinate rank is divided based on color coordinates (or chromaticity), and among them, a light-emitting diodes emitting light of colors that cannot be distinguished by a human eye are included in the same color coordinate rank.

Color coordinate ranks that a white light-emitting diode can have are divided into W, X, Y, Z, and A color coordinate ranks RW, RX, RY, RZ, and RA, in which values of x-coordinates and y-coordinates of the CIE color coordinates are increased.

For example, the W color coordinate rank RW is defined by a first rectangular region having vertexes P9 (0.261, 0.274), P10 (0.269, 0.269), P11 (0.257, 0.267), and P12 (0.265, 0.262), on the basis of a W color coordinate rank central point C5 (0.263, 0.268), and includes color coordinates in the first rectangular region.

The X color coordinate rank RX is defined by a second rectangular region having vertexes P9 (0.261, 0.274), P10 (0.269, 0.269), P7 (0.265, 0.281), and P8 (0.273, 0.276), on the basis of an X color coordinate rank central point C4 (0.267, 0.275), and includes color coordinates in the second rectangular region.

The Y color coordinate rank RY includes a region in a third rectangle having vertexes P7 (0.265, 0.281), P8 (0.273, 0.276), P5 (0.269, 0.288), and P6 (0.277, 0.283), on the basis of a Y color coordinate rank central point C3 (0.271, 0.283).

The Z color coordinate rank RZ includes a region in a fourth rectangle having vertexes P5 (0.269, 0.288), P6 (0.277, 0.283), P3 (0.273, 0.295), and P4 (0.281, 0.291), on the basis of a Z color coordinate rank central point C2 (0.275, 0.289).

The A color coordinate rank RA includes a region in a fifth rectangle having vertexes P3 (0.273, 0.295), P4 (0.281, 0.291), P1 (0.277, 0.303), and P2 (0.285, 0.298), on the basis of an A color coordinate rank central point C1 (0.279, 0.298). Here, the color coordinate ranks RW, RX, RZ, and RA do not overlap each other. However, the inventive concept is not limited thereto. Thus, a color coordinate ranking may be modified and subdivided.

Referring to FIG. 3, the light-emitting spectrum of the light-emitting diode 312 includes the dominant wavelength P1 and the phosphor wavelength P2. The dominant wavelength P1 is generated from a blue light-emitting diode chip and is distributed in a blue region BR. The phosphor wavelength P2 is generated by a phosphor and is distributed in a non-blue region NBR. The blue region BR has a wavelength range of about 350 nm to about 500 nm, and the non-blue region NBR may have a wavelength range of about 500 nm to about 800 nm. If a phosphor content of a light-emitting diode is different, the distribution of the phosphor wavelength P2 is different. Therefore, x-coordinate and y-coordinate values of a CIE color coordinate system of a white light emitted from a light-emitting diode is different. As a result, the light-emitting diode may emit light belonging to a different one of the color coordinate rank (RW, RX, RY, and RA).

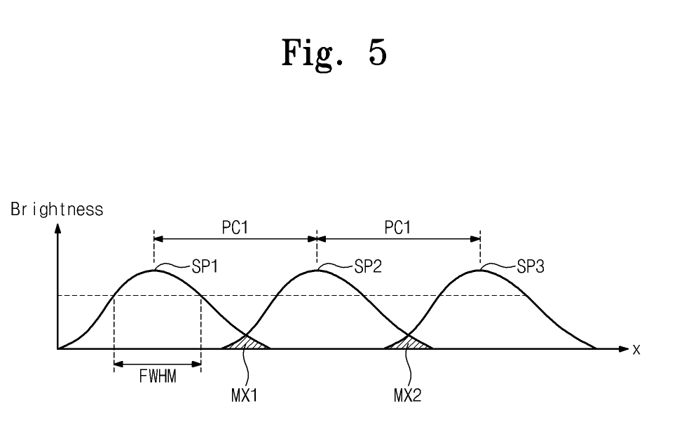

FIG. 4 is a plan view of a light source unit according to an embodiment of the inventive concept. FIG. 5 is a view illustrating the brightness distribution of a light source unit at the position I-I′ shown in FIG. 4. Referring to FIG. 4, the light-emitting diodes 312 may be arranged in a matrix on the circuit substrate 311. For example, the light-emitting diodes 312 may be arranged in a 3×7 matrix, but the present disclosure is not limited thereto. The light-emitting diodes 312 are spaced apart from each other by a first pitch PC1 in a first direction D1, and by a second pitch PC2 in a second direction D2. The first pitch PC1 and the second pitch PC2 may be identical to or different from each other.

Referring to FIG. 5, the brightness distribution of the light source unit 310 may not be uniform at the position I-I′, i.e., may have a ripple. That is, there are a first peak SP1, a second peak SP2, and a third peak SP3 each representing the highest brightness in correspondence to the respective central points of the light-emitting diodes 312. In addition, there are mixing regions MX1 and MX2, where the edges of adjacent peaks overlap.

A distance between the first and second peaks SP1 and SP2 and the mixing regions MX1 and MX2 are determined by the first or second pitch PC1 or PC2 (i.e., a distance between the light-emitting diodes) and a full width at half maximum (FWHM) of a light-emitting intensity of each light-emitting diode 312. As a value obtained by dividing the FWHM by the first or second pitch PC1 or PC2 becomes larger, a difference between the maximum value and the minimum value of brightness becomes greater. On the contrary, as a value obtained by dividing the FWHM by the first or second pitch PC1 or PC2 becomes smaller, the mixing regions MX1 and MX2 become smaller.

The number of light-emitting diodes 312 may be less than 20. A value obtained by dividing the FWHM by the first or second pitch PC1 or PC2, may be less than about 1.7. Accordingly, manufacturing costs may be reduced by reducing the number of the light-emitting diodes 312 in the light source unit 310.

Each light-emitting diode 312 may belong to the same rank. Accordingly, since each light-emitting diode 312 emits a white light having uniform color coordinates, the backlight assembly 300 provides to the display panel 410 a flat light having uniform color coordinates over an entire light-emitting surface of the backlight assembly 300. Furthermore, when the light-emitting diodes 312 belonging to the same rank are used, binning is not required, so that the number of the light-emitting diodes 312 in the backlight assembly 300 may be further reduced without considering the binning.

FIG. 6 is a block diagram of a liquid crystal display device according to an embodiment of the inventive concept. Referring to FIG. 6, the liquid crystal display device 1000 includes a timing controller 100, a data driver 210, a gate driver 220, a display panel 410, and a backlight assembly 300.

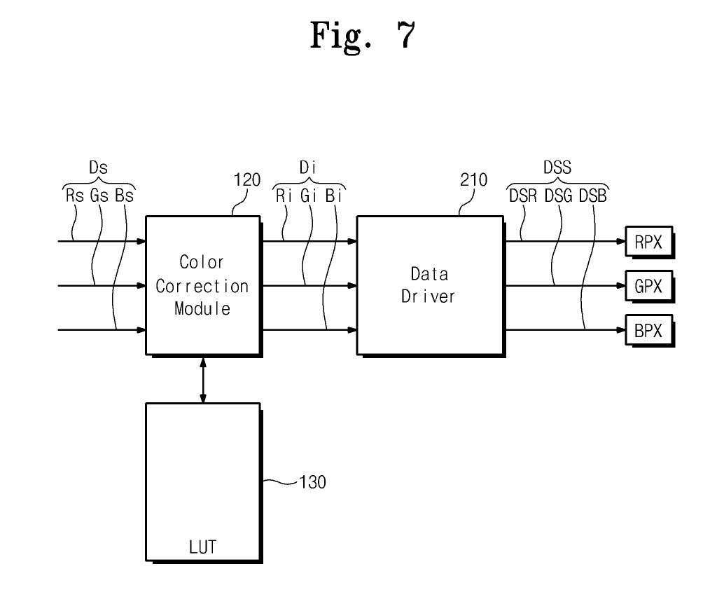

The timing controller 100 receives source data Ds and a driving signal CS provided from an external image source (not shown). The source data Ds may include image information. The external image source may include electronic devices such as a personal computer, a television receiver, a video player, and a digital cell phone. The timing controller 100 processes the source data Ds and the driving signal CS to fit a screen structure of the liquid crystal display device 1000, thereby generating a gate driving signal GCS, a data driving signal DCS, and image data Di. The image data Di controls light emitted from red, green, and blue pixels RPX, GPX, and BPX, shown in FIG. 7.

The gate driver 220 receives the gate driving signal GCS from the timing controller 100 to generate gate signals. The gate signals are sequentially supplied to gate lines GL1 to GLn.

The data driver 210 generates data signals on the basis of the data driving signal DCS and the image data Di. The data signals are supplied to a plurality of data lines DL1 to DLm.

The display panel 410 includes pixels PX11 to PXnm connected to corresponding gate lines among the gate lines GL1 to GLn and corresponding data lines among the data lines DL1 to DLm. Each of the pixels PX11 to PXnm may be one of red, green, and blue pixels RPX, GPX, and BPX. The red, green, and blue pixels RPX, GPX, and BPX include red, green, and blue color filters, respectively. Accordingly, a white light emitted from the backlight assembly 300 passes through the red, green, and blue color filters to become red, green, and blue lights. The red, green, and blue pixels RPX, GPX, and BPX adjust the intensities of red, green, and blue light emitted in response to the received gate and data signals. The display panel 410 mixes red, green, and blue light emitted from the red, green, and blue pixels RPX, GPX, and BPX, so as to determine the tone and brightness of an image.

Color coordinates of a gradation of a white image (hereinafter, referred to as white color gradation) displayed on the display panel 410 may vary depending on the color coordinate ranks RW, RX, RY, RZ, and RA of the light-emitting diodes 312 in the backlight assembly 300.

In more detail, the display panel 410 receives light emitted from the light-emitting diodes 312 to display a white image by mixing red, green, and blue light. Accordingly, according to the color coordinates RW, RX, RY, RZ, and RA received by the display panel 410, the color coordinates of a white color gradation of an image may vary. For example, if a color coordinate rank of the light-emitting diode is the rank RW having a relatively low color coordinate value, the white color gradation of an image has a low color coordinate value in correspondence thereto. On the contrary, if a color coordinate rank of the light-emitting diode is the rank RA having a relatively high color coordinate value, the white color gradation of an image has a high color coordinate value in correspondence thereto

FIG. 7 is a block diagram of a color correction module 120 according to an exemplary embodiment of the inventive concept. Referring to FIG. 7, the color correction module 120 controls the red, green, and blue pixels RPX, GPX, and BPX to compensate the color coordinates of a white color gradation of an image. In more detail, the color correction module 120 receives the source data Ds to generate the image data Di, and the data driver 210 receives the image data Di to generate the data signal DSS. The red, green, and blue pixels RPX, GPX, and BPX generate light in response to the corresponding data signal DSS.

The source data Ds includes gradation information of an image that is to be generated by each of the red, green, and blue pixels RPX, GPX, and BPX. For example, the source data Ds may include red, green, and blue source data Rs, Gs, and Bs, including gradation information on each of the red, green, and blue pixels RPX, GPX, and BPX.

The image data Di are generated to be fit for an operation mode of the display panel 410 in synchronization with the gate driving signal GCS and the data driving signal DCS. For example, the image data Di may include red, green, and blue image data Ri, Gi, and Bi controlling the intensities of light of light emitted from the red, green, and blue pixels RPX, GPX, and BPX. For example, the red, green, and blue image data Ri, Gi, and Bi may be generated by the timing controller 100 through additional compensation, for improving display quality, such as by dynamic capacitance compensation (DCC).

The data driver 210 generates the data signal DSS in response to the image data Di. For example, the data signal DSS includes red, green, and blue data signals DSR, DSG, and DSB that respectively correspond to the red, green, and blue pixels RPX, GPX, and BPX. The red, green, and blue pixels RPX, GPX, and BPX generate red, green, and blue light in response to the corresponding red, green, and blue data signals DSR, DSG, and DSB. As a result, the red, green, and blue pixels RPX, GPX, and BPX generate red, green, and blue light, respectively, in response to the image data Di.

The color correction module 120 converts the source data Ds into image data Di. In more detail, the color correction module 120 converts the source data Ds into the image data Di on the basis of a compensation value. For example, the color correction module 120 converts the red, green, and blue source data Rs, Gs, and Bs into the red, green, and blue image data Ri, Gi, and Bi, on the basis of predetermined red, green, and blue compensation values, in correspondence to color coordinate ranks of the light-emitting diodes 312. Moreover, the color correction module 123 may refer to a lookup table 130 storing the red, green, and blue compensation values.

The compensation value corrects the intensities of red, green, and blue light. In more detail, the red, green, and blue pixels RPX, GPX, and BPX generate red, green, and blue light, respectively, on the basis of the compensation value. That is, the red, green, and blue light may be corrected according to the compensation value.

The compensation value is preset with reference to the color coordinate rank of a light-emitting diode 312, to compensate the color coordinates of a white color gradation of an image to target color coordinates. Since the color coordinates of a white color gradation of an image vary depending on the color coordinate rank of the light-emitting diode 312, a compensation value may vary for different color coordinate ranks. For example, when the light-emitting diode 312 of the color coordinate rank RW is used, a correction value is determined with reference to the color coordinate rank RW. That is, the correction value is determine to correct the intensities of light of the red, green, and blue pixels RPX, GPX, and BPX, so that the white color gradation of an image, which is obtained when the light-emitting diode 312 of the color coordinate rank RW is used, is compensated to the target color coordinates.

The target color coordinates may be included in one of the color coordinate ranks RW, RX, RY, RZ, and RA shown in FIG. 2, and may be included in a color coordinate rank different from the white color gradation of an image. In order to increase the brightness of an image of the display panel 410, the target color coordinates may be included in a rank having a relatively large color coordinate value such as the color coordinate rank RA or the color coordinate rank RZ.

In this way, the color correction module 123 controls at least one of the red, green, and blue pixels RPX, GPX, and BPX to compensate the color coordinates of a white color gradation of an image, to the target color coordinates, using the image data Di converted based on the compensation value. Accordingly, since the compensation value is set in correspondence to the color coordinate rank of the light-emitting diode 312, regardless of the color coordinates of the light-emitting diode 312, the color coordinates of a white color gradation of an image may be compensated to the target color coordinates. Moreover, since the light-emitting diodes of all ranks can be mounted on the backlight assembly 300, regardless of the color coordinates of the diode 312, the yield of the light-emitting diode 312 is improved, and the manufacturing costs of the liquid crystal display device 1000 is reduced.

According to another exemplary embodiment of the inventive concept, the color correction module 120 may convert only one of the red, green, and blue source data Rs, Gs, and Bs into image data corresponding on the basis of a compensation value. Accordingly, the color coordinate value of a white color gradation of an image may be adjusted by reducing or increasing the intensity of a light of one of the red, green, and blue pixels RPX, GPX, and BPX. For example, instead of correcting the intensity of a light of the green pixel GPX, the intensity of a light of the blue pixel BPX is corrected. Accordingly, since blue light affects brightness less, the color coordinates of a white color gradation of an image may be adjusted, while maintaining the brightness of a white color gradation of an image.

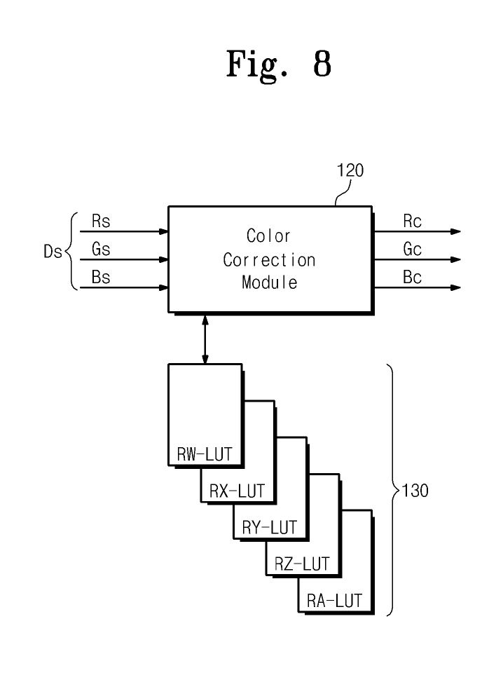

FIG. 8 is a block diagram illustrating a color correction module according to another exemplary embodiment of the inventive concept. Referring to FIG. 8, the color correction module 120 refers to a lookup table 130 including sub-lookup tables RW-LUT, RX-LUT, RY-LUT, RZ-LUT, and RA-LUT.

The sub-lookup tables RW-LUT, RX-LUT, RY-LUT, RZ-LUT, and RA-LUT each refer to a corresponding color coordinate rank among the color coordinate ranks RW, RX, RY, RZ, and RA, and store corresponding red, green, and blue compensation values. For example, the first sub-lookup table RW-LUT refers to the color coordinate rank RW and stores a corresponding first compensation value. In the same manner, the second to fifth sub-lookup tables RS-LUT, RY-LUT, RZ-LUT, and RA-LUT refer to the color coordinate ranks RX, RY, RZ, and RA and store corresponding second to fifth compensation values.

The color correction module 120 receives rank data on the color coordinate rank of the light-emitting diode 312 and selects and refers to a sub-lookup table corresponding to the received rank data.

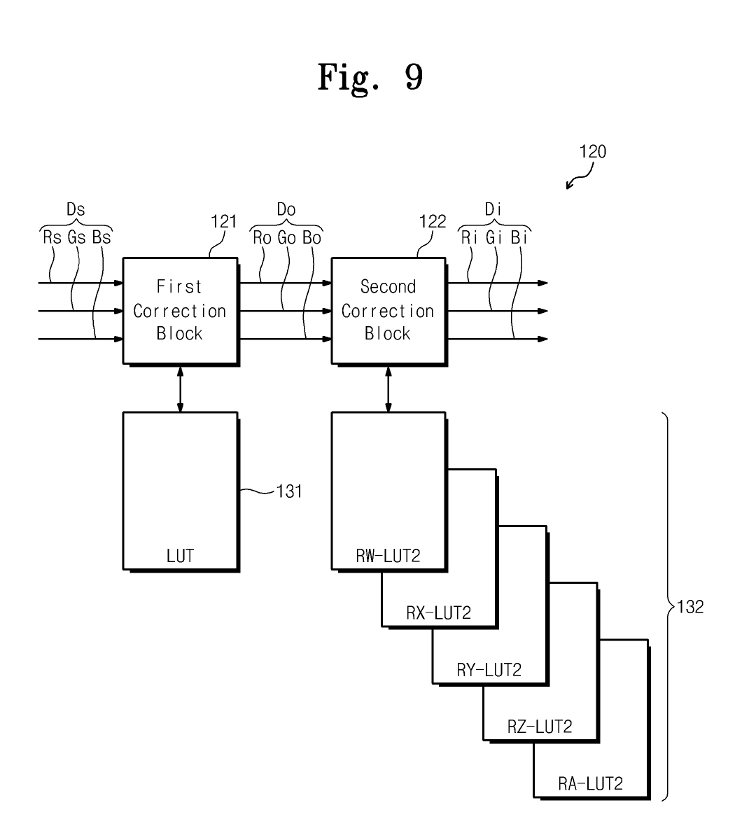

FIG. 9 is a block diagram illustrating a color correction module according another exemplary embodiment. Referring to FIG. 9, the color correction module 120 includes a first correction block 121 and a second correction block 122.

The first correction block 121 receives red, green, and blue source data Rs, Gs, and Bs, and generates red, green, and blue intermediate data Ro, Go, and Bo. In more detail, the first correction block 121 converts the red, green, and blue source data Rs, Gs, and Bs into the red, green, and blue intermediate data Ro, Go, and Bo on the basis of red, green, and blue correction gamma values.

The red, green, and blue correction gamma values are preset according to the gamma characteristics of the display device 1000. The red, green, and blue intermediate data Ro, Go, and Bo correspond to the red, green, and blue pixels RPX, GPX, and BPX, respectively.

The first correction block 121 refers to the first lookup table 131. The first lookup data 131 includes red, green, and blue correction gamma values.

The second correction block 122 receives red, green, and blue intermediate data Ro, Go, and Bo and generates red, green, and blue image data Ri, Gi, and Bi. In more detail, the second correction block 122 converts the red, green, and blue intermediate data Ro, Go, and Bo is into the red, green, and blue image data Ri, Gi, and Bi, on the basis of red, green, and blue correction gamma values.

The second correction block 122 refers to the second lookup table 132 storing preset red, green, and blue compensation values. The first lookup data 131 stores preset correction red, green, and blue gamma values. For example, the second lookup table 123 may include a plurality of sub-lookup tables RW-LUTS, RX-LUT2, RZ-LUT2, and RA-LUT2. The plurality of sub-lookup tables RW-LUTS, RX-LUT2, RZ-LUT2, and RA-LUT2 store preset red, green, and blue compensation values by referring to a corresponding color coordinate rank among the plurality of color coordinate ranks RW, RX, RY, RZ, and RA of the light-emitting diode 312. For example, the first sub-lookup table RW-LUT2 stores a preset first compensation value by referring to the W color coordinate rank RW. In the same manner, the second to fifth sub-lookup tables RX-LUT2, RY-LUT2, RZ-LUT2, and RA-LUT2 store preset second to fifth compensation values by referring to the color coordinate ranks RX, RY, RZ, and RA

The second correction block 122 receives rank data on the color coordinate rank of the light-emitting diode(s) 312 and selects and refers to a sub-lookup table(s) corresponding to the received rank data.

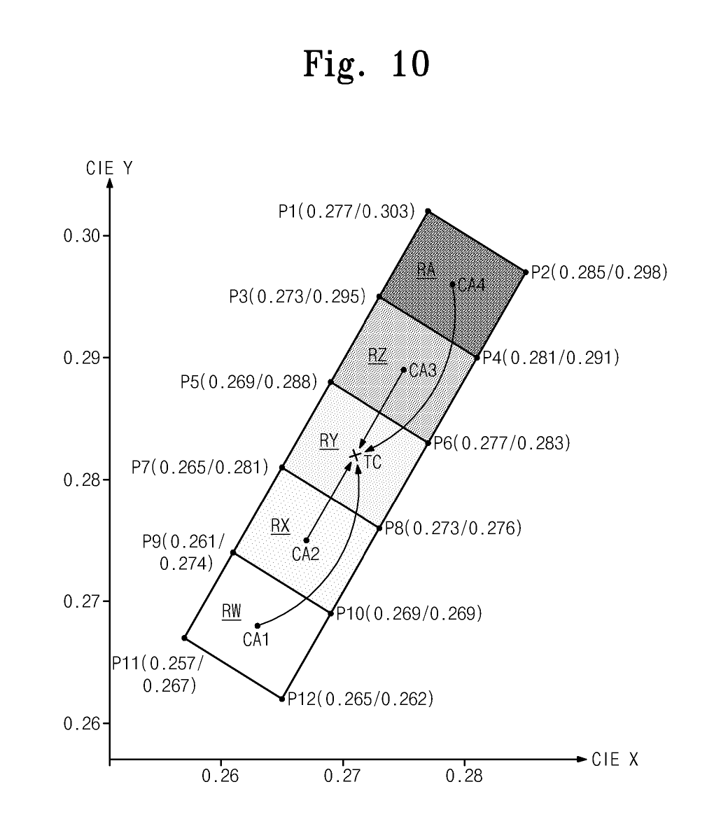

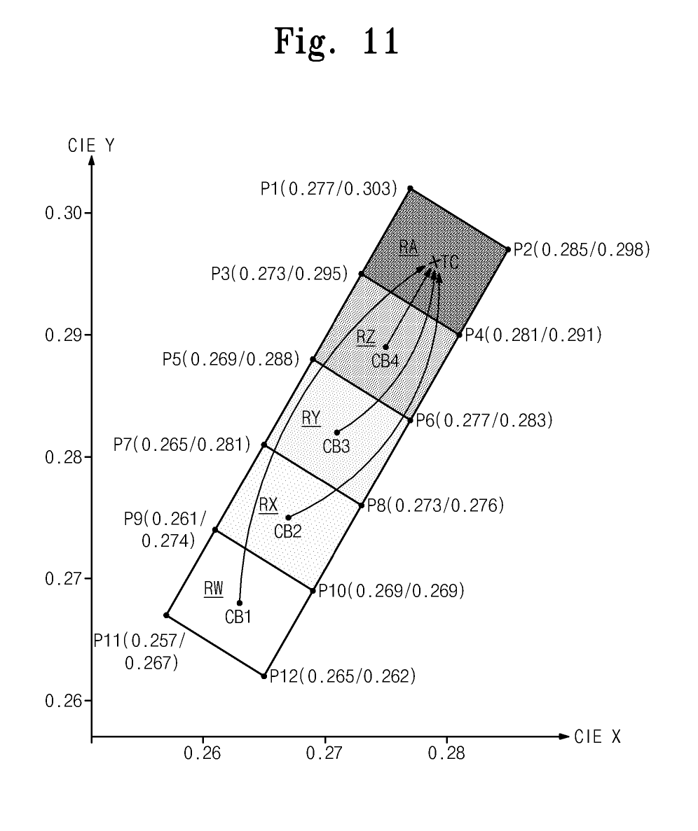

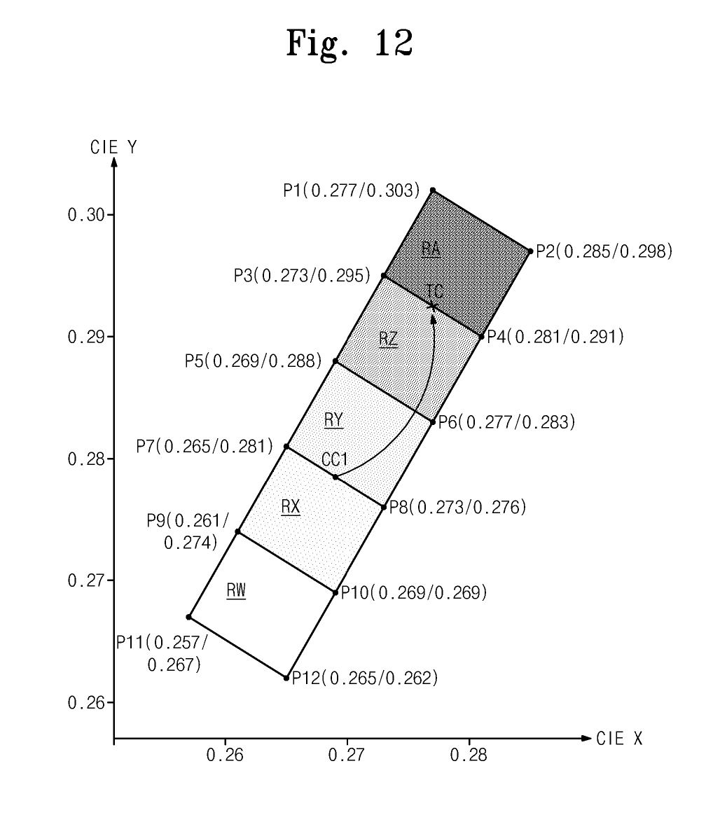

FIG. 10 is a color coordinate system representing the adjustment of the color coordinates of a white color gradation of an image to target color coordinates, according to an exemplary embodiment of the inventive concept. FIG. 11 is a color coordinate system representing the adjustment of that the color coordinates of a white color gradation of an image to target color coordinates, according to another exemplary embodiment of the inventive concept. FIG. 12 is a color coordinate system representing the adjustment of the color coordinates of a white color gradation of an image to target color coordinates, according to another exemplary embodiment of the inventive concept.

Referring to FIG. 10, the color coordinates of a white color gradation of an image is compensated to the target color coordinates. For example, in the case of a first liquid crystal display panel where the color coordinates of a white color gradation of an image has first color coordinates CA1, a first compensation value corresponding to the first color coordinates CA1 is selected. The intensities of red, green, and blue light corrected according to the first compensation value may correct the color coordinates of a white color gradation of an image with target color coordinates TC in the rank RY. In this case, the first compensation value reduces the intensity of blue light to increase a color coordinate value, so that the white color gradation of an image may be compensated to target color coordinates.

In the same manner, in the case of second to fourth liquid crystal display panels, where the color coordinates of a white color gradation of an image have second to fourth color coordinates CA2 to CA4, a corresponding compensation value is selected from among second to fourth compensation values. The intensities of light of red, green, and blue pixels are compensated according to the selected compensation value, and the white gradation of each image is compensated to the target color coordinates TC of the rank RY.

However, the present disclosure is not limited thereto, and the target color coordinates TC may be modified and implemented, and also may have one color coordinate rank among the color coordinate ranks RW to RA. For example, as shown in FIG. 11, the target color coordinates TC may belong to the rank RA. When the target color coordinates TC belong to the color coordinates included in the rank RA, the white color gradation of an image has color coordinates CB1, CB2, CB3, and CB4, which have lower values than the target color coordinates TC. Accordingly, by reducing only the intensity of blue light and by maintaining the intensity of blue light, the color coordinates of a white color gradation of an image is increased, so that the color coordinates of a white color gradation of an image are compensated to the target color coordinates TC, without brightness reduction.

Additionally, according to an exemplary embodiment of the inventive concept, as shown in FIG. 12, the white color gradation of an image having color coordinates CC1 on the boundary of the color coordinate ranks RX and RY may be compensated to have a value of the target color coordinates TC3, on the boundary of the color coordinate ranks RZ and RA.

As mentioned above, a liquid crystal display device compensates the white color gradation of an image displayed by adjusting the intensity of light emitted from at least one pixel among red, green, and blue pixels. Therefore, the display quality of a liquid crystal display device is improved, and light-emitting diodes having various color coordinate ranks are provided as a light source, so that manufacturing costs of a display device are reduced.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device comprising:
a light source unit comprising light-emitting diodes that belong to a same color coordinate rank, according to variations in the color coordinates of white light emitted thereby; and
a display panel comprising pixels configured to display an image by selectively emitting light received from the light-emitting diodes; and
a color correction module configured to compensate a color coordinate of a white color gradation of the image, by controlling the display panel to adjust an intensity of light emitted from one or more of the pixels, according to the color coordinate rank of corresponding light-emitting diodes that provide light to the pixels.

2. The device of claim 1, further comprising a data driver, wherein:
the color correction module is configured to generate image data using received image information;
the data driver is configured to generate a data signal in response to the image data;
the pixels comprise red, green, and blue pixels that display the image according to the image data; and
the color correction module is configured to convert the source data into image data based on compensation values corresponding to the color coordinate rank.

3. The device of claim 2, wherein:
the source data comprises red, green, and blue source data;
the image data comprises red, green, and blue image data; and
the compensation values comprises red, green, and blue compensation values,
wherein the red, green, and blue source data is converted into the red, green, and blue image data corresponding to the red, green, and blue pixels, respectively, on the basis of red, green, and blue compensation values.

4. The device of claim 3, wherein the color correction module adjusts only the intensity of light emitted from one or more of the blue pixels.

5. The device of claim 3, further comprising a lookup table comprising the red, green, and blue compensation values,
wherein the color correction module refers to the lookup table.

6. The device of claim 5, wherein:
the lookup table comprises sub-lookup tables; and
each of the sub-lookup tables respectively stores red, green, and blue compensation values corresponding to different color coordinate ranks.

7. The device of claim 6, wherein the color correction module is configured to receive stored rank data corresponding to the color coordinate rank of the light-emitting diodes, and to select and refer to sub-lookup tables corresponding to the received rank data.

8. The device of claim 3, wherein the color correction module comprises:
a first correction block configured to convert the red, green, and blue source data into red, green, blue intermediate data, respectively, on the basis of red, green, and blue correction gamma values; and
a second correction block configured to convert the red, green, and blue intermediate data into red, green, and blue image data, on the basis of the red, green, and blue correction values.

9. The device of claim 8, further comprising:
a first lookup table comprising the red, green, and blue correction gamma values; and
a second lookup table comprising the red, green, and blue compensation values,
wherein the first and second correction blocks are configured to read from the first and second lookup tables, respectively.

10. The device of claim 9, wherein:
the second lookup table comprises sub-lookup tables; and
each of the sub-lookup tables respectively comprises red, green, and blue compensation values corresponding to different color coordinate ranks.

11. The device of claim 1, wherein the light-emitting diodes are arranged so that a value obtained by dividing a full width at half maximum of light-emitting intensities of adjacent ones of the light-emitting diodes, by a distance between the adjacent light-emitting diodes, is less than about 1.7.

12. A method of driving a display device to display an image by using light emitted from light-emitting diodes that belong to a same color coordinate rank, according to variations in the color coordinates of white light emitted thereby, the method comprising:
receiving external source data;
converting the source data into image data on the basis of a compensation value corresponding to the color coordinate rank of the light emitting diodes;
converting the image data into a data signal; and
providing the data signal to pixels; and
correcting the intensity of light emitted from at least one of the pixels to compensate a color coordinate of a white color gradation of the image.

13. The method of claim 12, wherein:
the source data comprises red, green, and blue source data;
the compensation value comprises red, green, and blue compensation values; and
the image data comprise red, green, and blue image data corresponding to the red, green, and blue pixels;
wherein the converting of the image data comprises converting the red, green, and blue source data into the red, green, and blue image data, respectively, by using the red, green, and blue compensation values.

14. The method of claim 13, wherein the converting of the image data comprises reading the red, green, and blue compensation values from a lookup table comprising the red, green, and blue compensation values.

15. The method of claim 14, wherein:
the lookup table comprises sub-lookup tables; and
each of the sub-lookup tables stores red, green, and blue compensation values corresponding to different color coordinate ranks.

16. The method of claim 15, further comprising:
receiving rank data on the color coordinate rank of the light-emitting diodes; and
selecting a sub-lookup table corresponding to the received rank data.

17. The method of claim 13, wherein the converting of the image comprises:
performing a first correction operation to convert the red, green, and blue source data into red, green, blue intermediate data, respectively, on the basis of preset red, green, and blue correction gamma values; and
performing a second correction operation to convert the red, green, and blue intermediate data into red, green, and blue image data, on the basis of the red, green, and blue compensation values.

18. The method of claim 17, further comprising:
a first lookup table comprising the red, green, and blue correction gamma values; and
a second lookup table comprising the red, green, and blue compensation values,
wherein the first and second correction operations read from the first and second lookup tables, respectively.

19. The method of claim 18, wherein:
the second lookup table comprises a plurality of sub-lookup tables; and
each of the sub-lookup tables stores red, green, and blue compensation values corresponding to different coordinate ranks.

20. The method of claim 19, further comprising:
receiving rank data on color coordinate ranks of the light emitting diodes; and
selecting a sub-lookup table corresponding to the received rank data.
